(19) United States
(12) Patent Application Publication
(10) Pub. No.: US 2025/0151151 A1
(43) Pub. Date: May 8, 2025

(54) METHOD AND APPARATUS FOR REPORTING ENHANCED EARLY MEASUREMENT RESULT IN NEXT GENERATION MOBILE COMMUNICATION SYSTEM

(71) Applicant: Samsung Electronics Co., Ltd., Suwon-si (KR)

(72) Inventors: Sangyeob JUNG, Suwon-si (KR); Seungri JIN, Suwon-si (KR)

(21) Appl. No.: 18/933,363

(22) Filed: Oct. 31, 2024

(30) Foreign Application Priority Data
Nov. 2, 2023 (KR) 10-2023-0150244

(51) Int. Cl. H04W 76/20; H04W 24/10; H04W 76/19; H04W 76/30

(52) U.S. Cl. CPC H04W 76/20; H04W 24/10; H04W 76/19; H04W 76/30

(57) ABSTRACT

The disclosure relates to a fifth generation (5G) or sixth generation (6G) communication system for supporting higher data rates. A method performed by a terminal in a wireless communication system. The method includes receiving, from a base station, a radio resource control (RRC) release message including measurement configuration information, entering an RRC idle state or an RRC inactive state, based on the RRC release message, receiving, from the base station, system information including information indicating whether the terminal performs a measurement while camping on a cell and report an availability of the measurement in case of establishing or resuming a connection in the cell, performing the measurement, based on the measurement configuration information in the RRC idle state or the RRC inactive state, performing an RRC connection procedure with the base station, receiving, from the base station, a user equipment (UE) information request message including a request for a validated measurement, and transmitting, to the base station, a UE information response message including the validated measurement.

### CROSS-REFERENCE TO RELATED APPLICATION(S)

This application is based on and claims priority under 35 U.S.C. § 119 (a) of a Korean patent application number 10-2023-0150244, filed on Nov. 2, 2023, in the Korean Intellectual Property Office, the disclosure of which is incorporated by reference herein in its entirety.

### BACKGROUND

### 1. Field

The disclosure relates to operations of a user equipment (UE) and a base station in a mobile communication system. More particularly, the disclosure relates to a method and an apparatus for transmitting enhanced early measurement results.

### 2. Description of Related Art

Fifth generation (5G) mobile communication technologies define broad frequency bands to enable high transmission rates and new services, and may be implemented not only in “Sub 6 GHz” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

In the initial stage of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive multiple-input multiple-output (MIMO) for alleviating radio-wave path loss and increasing radio-wave transmission distances in mm Wave, numerology (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large-capacity data transmission and a polar code for highly reliable transmission of control information, layer 2 (L2) pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and a method for effectively providing measurement reporting in a communication system.

Additional aspects will be set forth in part in the description which follows and, in part, will be apparent from the description, or may be learned by practice of the presented embodiments.

In accordance with an aspect of the disclosure, a method performed by a terminal is provided. The method includes receiving, from a base station, a radio resource control (RRC) release message including measurement configuration information, entering an RRC idle state or an RRC inactive state, based on the RRC release message, receiving, from the base station, system information including information indicating whether the terminal performs a measurement while camping on a cell and report an availability of the measurement in case of establishing or resuming a connection in the cell, performing the measurement, based on the measurement configuration information in the RRC idle state or the RRC inactive state, performing an RRC connection procedure with the base station, receiving, from the base station, a user equipment (UE) information request message including a request for a validated measurement, and transmitting, to the base station, a UE information response message including the validated measurement.

In accordance with another aspect of the disclosure, a method performed by a base station is provided. The method includes transmitting a radio resource control (RRC) release message including measurement configuration information to a terminal, transmitting, based on the RRC release message, to a terminal in an RRC idle state or an RRC inactive state, system information including information indicating whether a measurement is performed while the terminal camps on a cell and report an availability of the measurement in case of establishing or resuming a connection in the cell, performing an RRC connection procedure with the terminal, transmitting, to the terminal, a user equipment (UE) information request message including a request for a validated measurement, and receiving, from the terminal, a UE information response message including the validated measurement.

In accordance with another aspect of the disclosure, a terminal is provided. The terminal includes a transceiver, and a controller connected to the transceiver, wherein the controller is configured to receive, from a base station, a radio resource control (RRC) release message including measurement configuration information, enter an RRC idle state or an RRC inactive state, based on the RRC release message, receive, from the base station, system information including information indicating whether the terminal performs a measurement while camping on a cell and report an availability of the measurement in case of establishing or resuming a connection in the cell, perform the measurement, based on the measurement configuration information in the RRC idle state or the RRC inactive state, perform an RRC connection procedure with the base station, receive, from the base station, a user equipment (UE) information request message including a request for a validated measurement, and transmit, to the base station, a UE information response message including the validated measurement.

In accordance with another aspect of the disclosure, a base station is provided. The base station includes a transceiver, and a controller connected to the transceiver, wherein the controller is configured to transmit a radio resource control (RRC) release message including measurement configuration information to a terminal, transmit, based on the RRC release message, to a terminal in an RRC idle state or an RRC inactive state, system information including information indicating whether a measurement is performed while the terminal camps on a cell and report an availability of the measurement in case of establishing or resuming a connection in the cell, perform an RRC connection procedure with the terminal, transmit, to the terminal, a user equipment (UE) information request message including a request for a validated measurement, and receive, from the terminal, a UE information response message including the validated measurement.

According to an embodiment of the disclosure, measurement reporting may be effectively performed in a communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates a structure of a long-term evolution (LTE) system according to an embodiment of the disclosure;

FIG. 1B illustrates a radio protocol structure of an LTE system according to an embodiment of the disclosure;

FIG. 1C illustrates a structure of a next-generation mobile communication system according to an embodiment of the disclosure;

FIG. 1D illustrates a radio protocol structure of a next-generation mobile communication system according to an embodiment of the disclosure;

FIG. 1E is a flow diagram illustrating an operation in which a user equipment (UE) in an RRC idle mode (RRC_IDLE) stores and reports early measurement results according to the related art;

FIG. 1F is a flow diagram illustrating an operation in which a UE in an RRC inactive mode (RRC_INACTIVE) stores and reports early measurement results according to the related art;

FIG. 1G is a flow diagram illustrating an operation in which a base station enables a UE to perform enhanced early measurement results in a next-generation mobile communications system according to an embodiment of the disclosure;

FIG. 1H is a flow diagram illustrating an operation in which a UE that is configured to perform an enhanced early measurement in a next-generation mobile communication system transmits, to a base station, an indicator indicating information about a presence or absence of a result value for the measurement, or an indicator or information indicating that the measurement should continue according to an embodiment of the disclosure;

FIG. 1I is a block diagram illustrating an internal structure of a UE according to an embodiment of the disclosure; and

FIG. 1J is a block diagram illustrating a configuration of a new radio (NR) base station according to an embodiment of the disclosure.

Throughout the drawings, it should be noted that like reference numbers are used to depict the same or similar elements, features, and structures

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, terms and names defined in the 3rd generation partnership project long term evolution (3GPP LTE) standards will be used for the sake of descriptive convenience. However, the disclosure is not limited by these terms and names, and may be applied in the same way to systems that conform other standards. In the disclosure, the term “evolved node B (eNB)” may be interchangeably used with the term “next generation node B (gNB)” for the sake of descriptive convenience. That is, a base station described as “eNB” may refer to “gNB”.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

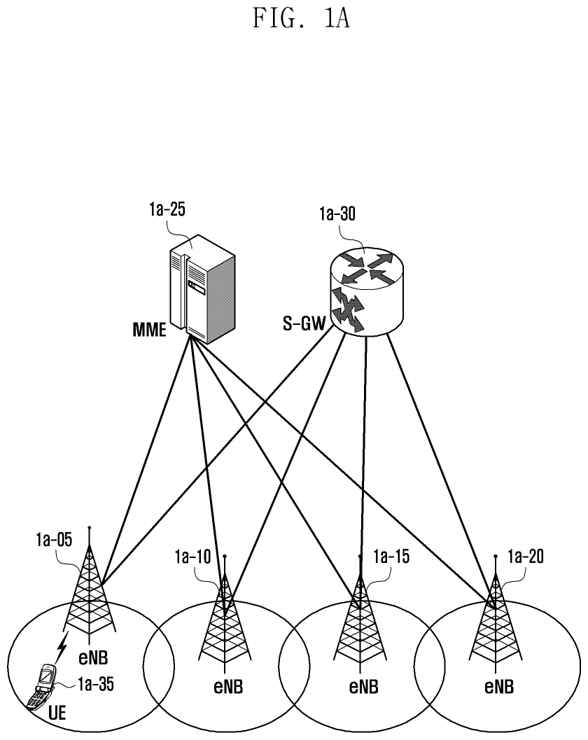

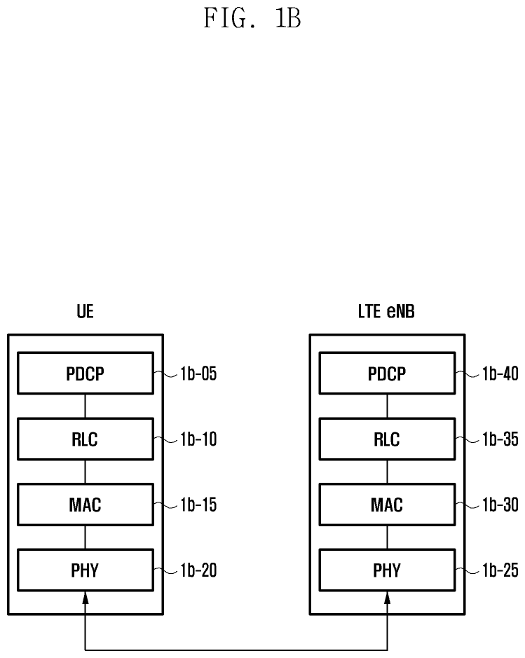

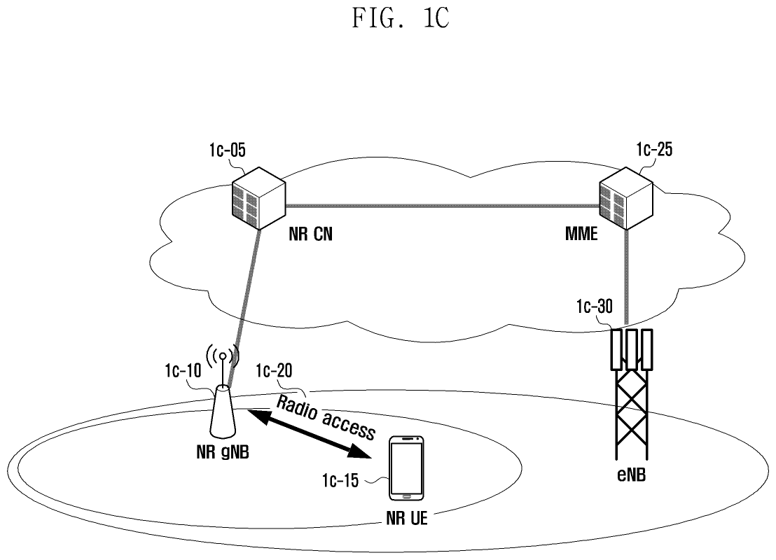

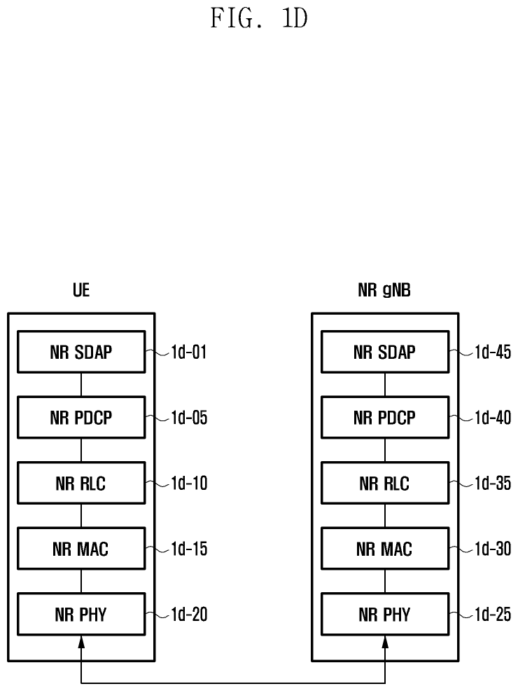

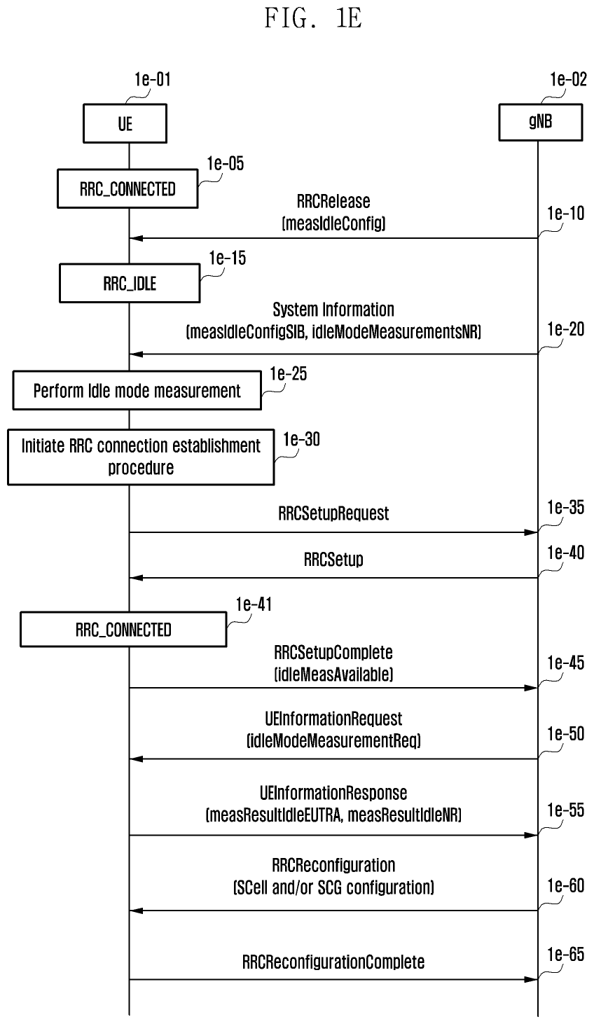

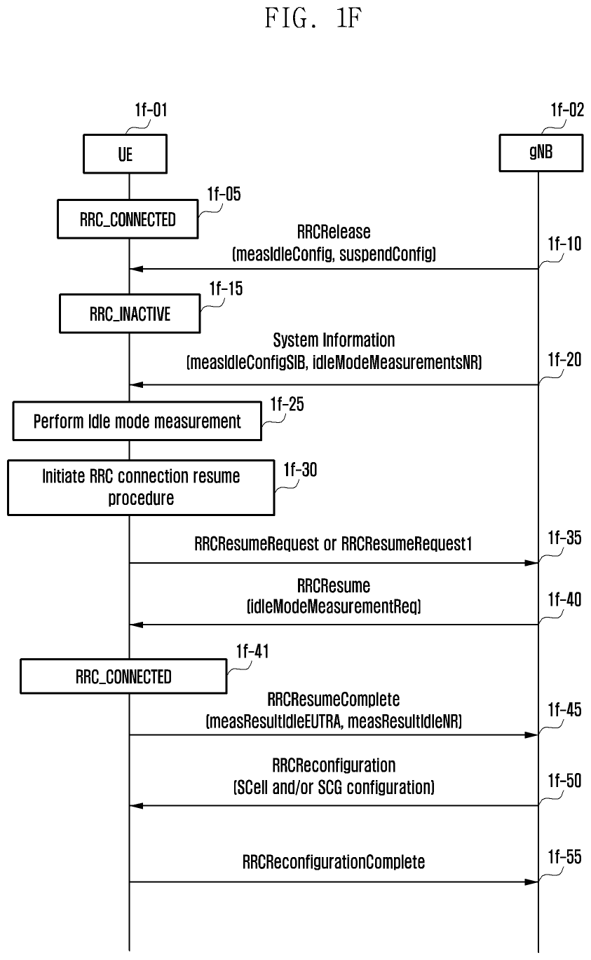

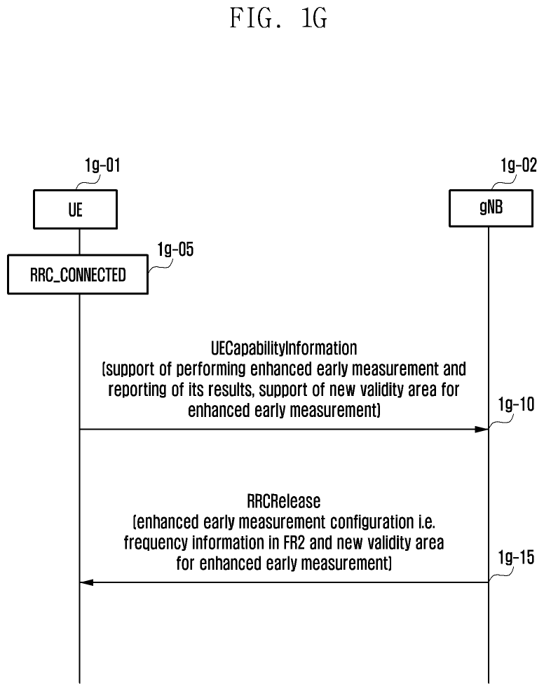

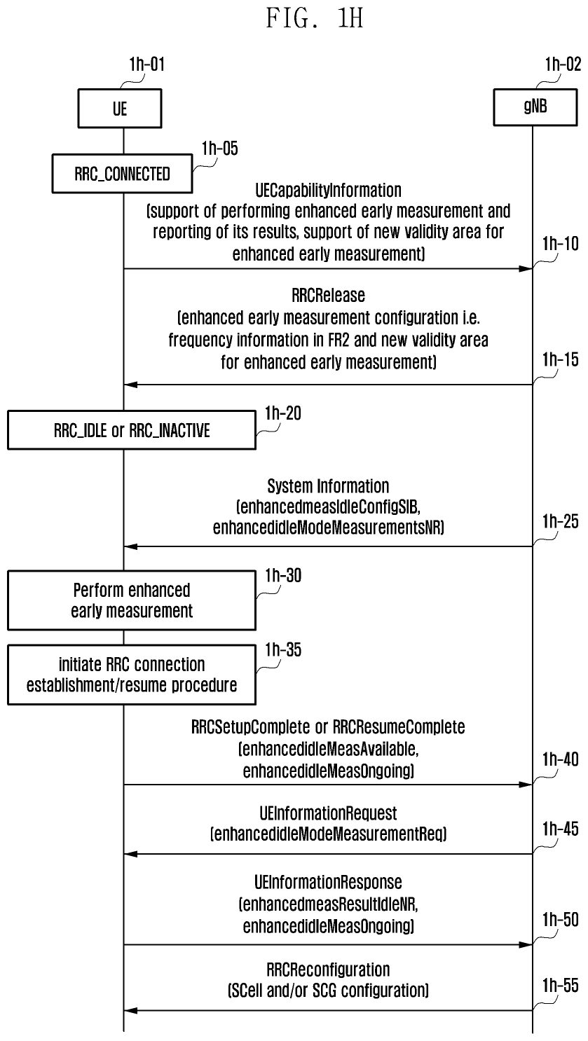

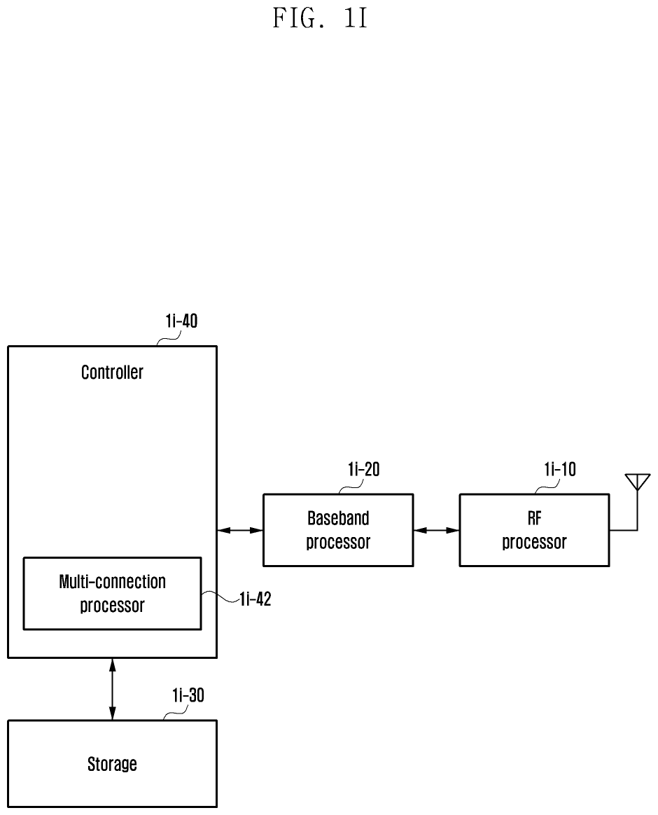

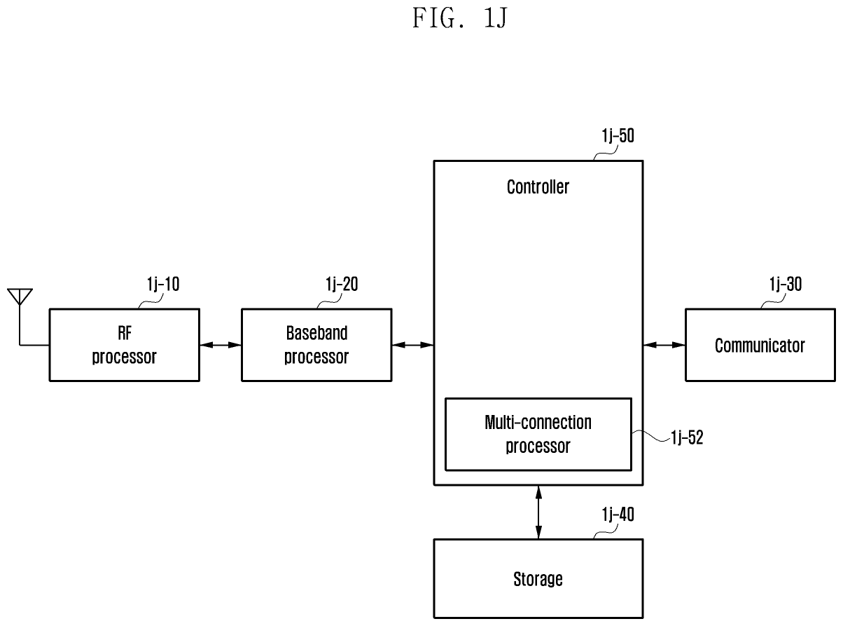

FIG. 1A illustrates a structure of an LTE system according to an embodiment of the disclosure.

Referring to FIG. 1A, as illustrated therein, a radio access network of an LTE system includes next-generation base stations (evolved node Bs, hereinafter ENBs, node Bs, or base stations) 1a-05, 1a-10, 1a-15, and 1a-20, a mobility management entity (MME) 1a-25, and a serving gateway (S-GW) 1a-30. A user equipment (hereinafter UE or terminal) 1a-35 accesses an external network through the ENBs 1a-05 to 1a-20 and the S-GW 1a-30.

In FIG. 1A, the ENBs 1a-05 to 1a-20 each correspond to a conventional node B in a universal mobile telecommunications system (UMTS) system. The ENBs are connected to the UE 1a-35 through a radio channel, and perform more complicated roles than the conventional node Bs. In the LTE system, since all user traffic including real-time services, such as voice over internet protocol (VOIP) via the Internet protocol, is serviced through a shared channel, a device that collects state information, such as buffer states, available transmit power states, and channel states of UEs, and performs scheduling accordingly is required, and the ENBs 1-05 to 1-20 serve as the device. In general, one ENB controls multiple cells. For example, in order to implement a transfer rate of 100 Mbps, the LTE system uses orthogonal frequency division multiplexing (hereinafter referred to as OFDM) as a radio access technology in a bandwidth of, for example, 20 MHz. Furthermore, the LTE system employs an adaptive modulation & coding (hereinafter referred to as AMC) scheme for determining a modulation scheme and a channel coding rate according to a channel state of a UE. The S-GW 1a-30 is a device that provides a data bearer, and generates or removes a data bearer under the control of the MME 1a-25. The MME is a device responsible for various control functions as well as a mobility management function for a UE, and is connected to multiple base stations.

FIG. 1B illustrates a radio protocol structure of an LTE system according to an embodiment of the disclosure.

Referring to FIG. 1B, a radio protocol of an LTE system includes a packet data convergence protocol (PDCP) 1b-05 or 1b-40, a radio link control (RLC) 1b-10 or 1b-35, and a medium access control (MAC) 1b-15 or 1b-30 on each of UE and ENB sides. The packet data convergence protocol (PDCP) 1b-05 or 1b-40 is responsible for operations such as internet protocol (IP) header compression/reconstruction. The main functions of the PDCP are summarized as follows.
Header compression and decompression: robust header compression (ROHC) only
Transfer of user data
In-sequence delivery of upper layer protocol data units (PDUs) at PDCP re-establishment procedure for RLC acknowledged mode (AM)
For split bearers in dual connectivity (DC) (only support for RLC AM): PDCP PDU routing for transmission and PDCP PDU reordering for reception
Duplicate detection of lower layer service data units (SDUs) at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

The radio link control (hereinafter referred to as RLC) 1b-10 or 1b-35 reconfigures a PDCP protocol data unit (PDU) into an appropriate size to perform an automatic repeat request (ARQ) operation. The main functions of the RLC are summarized as follows.
Transfer of upper layer PDUs
Error Correction through ARQ (only for AM data transfer)
Concatenation, segmentation and reassembly of RLC SDUs (only for unacknowledged mode (UM) and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MAC 1b-15 or 1b-30 is connected to several RLC layer devices configured in a single terminal, and performs operations of multiplexing RLC PDUs to a MAC PDU and demultiplexing a MAC PDU to RLC PDUs. The main functions of the MAC are summarized as follows.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through hybrid automatic repeat request (HARQ)
Priority handling between logical channels of one UE
Priority handling between UEs by means of dynamic scheduling
Multimedia broadcast/multicast service (MBMS) identification
Transport format selection
Padding

A physical layer 1b-20 or 1b-25 performs operations of channel-coding and modulating upper layer data, thereby obtaining OFDM symbols, and delivering the same through a radio channel, or demodulating OFDM symbols received through the radio channel, channel-decoding the same, and delivering the same to the upper layer.

FIG. 1C illustrates a structure of a next-generation mobile communication system according to an embodiment of the disclosure.

Referring to FIG. 1C, a radio access network of a next-generation mobile communication system (hereinafter NR or 5G) includes a next-generation base station (new radio node B, hereinafter NR gNB or NR base station) 1c-10, and a new radio core network (NR CN) 1c-05. A user terminal (new radio user equipment, hereinafter NR UE or NR terminal) 1c-15 accesses an external network via the NR gNB 1c-10 and the NR CN 1c-05.

In FIG. 1C, the NR gNB 1c-10 corresponds to an evolved node B (eNB) of a conventional LTE system. The NR gNB 1c-10 is connected to the NR UE 1c-15 through a radio channel (i.e., radio access 1c-20), and may provide outstanding services as compared to a conventional node Bs. In the next-generation mobile communication system, since all user traffic including real-time services, such as voice over IP (VOIP) via the Internet protocol, is serviced through a shared channel, a device that collects state information, such as buffer states, available transmit power states, and channel states of UEs, and performs scheduling accordingly is required, and the NR gNB 1c-10 serve as the device. In general, one NR gNB controls multiple cells. In order to implement ultrahigh-speed data transfer beyond the current LTE, the next-generation mobile communication system may have a wider bandwidth than the existing maximum bandwidth, may employ an orthogonal frequency division multiplexing (hereinafter referred to as OFDM) as a radio access technology, and may additionally integrate a beamforming technology therewith. Furthermore, the next-generation mobile communication system employs an adaptive modulation & coding (hereinafter referred to as AMC) scheme for determining a modulation scheme and a channel coding rate according to a channel state of a UE. The NR CN 1c-05 performs functions such as mobility support, bearer configuration, and quality of service (QOS) configuration. The NR CN is a device responsible for various control functions as well as a mobility management function for a UE, and is connected to multiple base stations. In addition, the next-generation mobile communication system may interwork with the existing LTE system, and the NR CN is connected to an MME 1c-25 via a network interface. The MME is connected to an eNB 1c-30 that is an existing base station.

FIG. 1D illustrates a radio protocol structure of a next-generation mobile communication system according to an embodiment of the disclosure.

FIG. 1D illustrates a radio protocol structure of a next-generation mobile communication system to which the disclosure is applicable.

Referring to FIG. 1D, a radio protocol of a next-generation mobile communication system includes an NR SDAP 1d-01 or 1d-45, an NR PDCP 1d-05 or 1d-40, an NR RLC 1d-10 or 1d-35, and an NR MAC 1d-15 or 1d-30 on each of UE and NR base station sides.

The main functions of the NR SDAP 1d-01 or 1d-45 may include some of functions below.
Transfer of user plane data
Mapping between a QoS flow and a data radio bearer (DRB) for both downlink (DL) and uplink (UL)
Marking QoS flow ID in both DL and UL packets
Reflective QoS flow to DRB mapping for UL SDAP PDUs

With regard to the SDAP layer device, the UE may be configured, through an RRC message, whether to use the header of the SDAP layer device or whether to use functions of the SDAP layer device for each PDCP layer device or each bearer or each logical channel, and if an SDAP header is configured, the non-access stratum (NAS) QoS reflection configuration 1-bit indicator (NAS reflective QoS) and the AS QoS reflection configuration 1-bit indicator (AS reflective QoS) of the SDAP header may be indicated so that the UE may update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 1d-05 or 1d-40 may include some of functions below.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The reordering of the NR PDCP device refers to a function of reordering PDCP PDU received from a lower layer in an order based on PDCP sequence numbers (SNs), and may include a function of transferring data to an upper layer according to a rearranged order, may include a function of directly transferring data without considering order, may include a function of rearranging order to record lost PDCP PDUs, may include a function of reporting the state of lost PDCP PDUs to a transmission side, or may include a function of requesting retransmission of lost PDCP PDUs.

The main functions of the NR RLC 1d-10 or 1d-35 may include some of functions below.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery of the NR RLC device refers to a function of transferring RLC SDUs received from a lower layer to an upper layer in sequence, and may include a function of, if one original RLC SDU is divided into several RLC SDUs and then the RLC SDUs are received, reassembling the several RLC SDUs and transferring the reassembled RLC SDUs, may include a function of rearranging received RLC PDUs with reference to RLC sequence numbers (SNs) or PDCP sequence numbers (SNs), may include a function of rearranging order to record lost RLC PDUs, may include a function of reporting the state of lost RLC PDUs to a transmission side, may include a function of requesting retransmission of lost RLC PDUs, may include a function of, if there is a lost RLC SDU, sequentially transferring only RLC SDUs before the lost RLC SDU to an upper layer, may include a function of, although there is a lost RLC SDU, if a predetermined timer has expired, sequentially transferring, to an upper layer, all the RLC SDUs received before the timer is started, or may include a function of, although there is a lost RLC SDU, if a predetermined timer has expired, sequentially transferring all the RLC SDUs received up to the current, to an upper layer. In addition, the in-sequence delivery of the NR RLC device may include a function of processing RLC PDUs in the received order (regardless of the sequence number order, in the order of arrival) and delivering same to the PDCP device regardless of the order (out-of-sequence delivery), and may include a function of, in the case of segments, receiving segments which are stored in a buffer or which are to be received later, reconfiguring same into one complete RLC PDU, processing, and delivering same to the PDCP device. The NR RLC layer may include no concatenation function, which may be performed in the NR MAC layer or replaced with a multiplexing function of the NR MAC layer.

The out-of-sequence delivery of the NR RLC device refers to a function of instantly delivering RLC SDUs received from the lower layer to the upper layer regardless of the order, may include a function of, if multiple RLC SDUs received, into which one original RLC SDU has been segmented, are received, reassembling and delivering the same, and may include a function of storing the RLC SN or PDCP SN of received RLC PDUs, and recording RLC PDUs lost as a result of reordering.

The NR MAC 1d-15 or 1d-30 may be connected to multiple NR RLC layer devices configured in one UE, and the main functions of the NR MAC may include some of functions below.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

An NR PHY layer 1d-20 or 1d-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

FIG. 1E is a flow diagram illustrating an operation in which a UE in an RRC idle mode (RRC_IDLE) stores and reports early measurement results according to the related art.

Referring to FIG. 1E, a UE 1e-01 may be in an RRC connected mode (RRC_CONNECTED) by establishing an RRC connection with an NR base station 1e-02 (operation 1e-05).

In operation 1e-10, the UE 1e-01 in the RRC connected mode may receive an RRCRelease message from the NR base station 1e-02. The RRCRelease message may contain a measIdleConfig containing an early measurement configuration (idle/inactive measurement configuration). The measConfig may contain at least one of the following pieces of information.
measIdleCarrierListNR: list of NR carriers to perform early measurement (idle/inactive measurement) in an RRC idle mode or RRC inactive mode (RRC_INACTIVE). Each NR carrier may contain at least one of the following pieces of information.

| MeasIdleCarrierNR-r16 ::= | SEQUENCE { | |
|---|---|---|
| carrierFreq-r16 | ARFCN-ValueNR, | |
| ssbSubcarrierSpacing-r16 | SubcarrierSpacing, | |
| frequencyBandList | MultiFrequencyBandListNR | OPTIONAL, |

-- Need R

| | | |
|---|---|---|
| measCellListNR-r16 | CellListNR-r16 | OPTIONAL, |

-- Need R

| reportQuantities-r16 | ENUMERATED {rsrp, rsrq, both}, | |
|---|---|---|
| qualityThreshold-r16 | SEQUENCE { | |
| idleRSRP-Threshold-NR-r16 | RSRP-Range | OPTIONAL, |

-- Need R

| | | |
|---|---|---|
| idleRSRQ-Threshold-NR-r16 | RSRQ-Range | OPTIONAL |

-- Need R

| | |
|---|---|
| } | OPTIONAL, -- Need R |

| | |
|---|---|
| ssb-MeasConfig-r16 | SEQUENCE { |
| nrofSS-BlocksToAverage-r16 | INTEGER (2..maxNrofSS-BlocksToAverage) |

OPTIONAL, -- Need S

| | |
|---|---|
| absThreshSS-BlocksConsolidation-r16 | ThresholdNR |

OPTIONAL, -- Need S

| | | |
|---|---|---|
| smtc-r16 | SSB-MTC | OPTIONAL, |

-- Need S

| | | |
|---|---|---|
| ssb-ToMeasure-r16 | SSB-ToMeasure | OPTIONAL, |

-- Need S

| | |
|---|---|
| deriveSSB-IndexFromCell-r16 | BOOLEAN, |

| | |
|---|---|
| ss-RSSI-Measurement-r16 | SS-RSSI-Measurement |

OPTIONAL -- Need S

| | |
|---|---|
| } | OPTIONAL, -- Need S |
| beamMeasConfigIdle-r16 | Beam MeasConfigIdle-NR-r16 |

OPTIONAL, -- Need R
...
}

measIdleCarrierListEUTRA: list of E-UTRA carriers to perform measurement in an RRC idle mode. Each E-UTRA carrier may contain at least one of the following pieces of information.

| | |
|---|---|
| MeasIdleCarrierEUTRA-r16 ::= | SEQUENCE { |
| carrierFreqEUTRA-r16 | ARFCN-ValueEUTRA, |
| allowedMeasBandwidth-r16 | EUTRA-AllowedMeasBandwidth, |
| measCellListEUTRA-r16 | CellListEUTRA-r16 |

OPTIONAL, -- Need R

| | |
|---|---|
| reportQuantitiesEUTRA-r16 | ENUMERATED {rsrp, rsrq, both}, |
| qualityThresholdEUTRA-r16 | SEQUENCE { |
| idleRSRP-Threshold-EUTRA-r16 | RSRP-RangeEUTRA |

OPTIONAL, -- Need R

| | |
|---|---|
| idleRSRQ-Threshold-EUTRA-r16 | RSRQ-RangeEUTRA-r16 |

```
OPTIONAL -- Need R
  }
OPTIONAL, -- Need S
  ...
}
```

measIdleDuration: a duration value with regard to performing early measurement in an RRC idle mode or RRC inactive mode (T331 timer value)
validityAreaList: list of frequencies for which the UE is requested to perform early measurement in an RRC idle mode or RRC inactive mode and/or list of cells according to each frequency

A UE in an RRC connected mode may apply the measIdleConfig contained in the RRCRelease message. For example, in case that the measIdleConfig is set to setup,

The UE may store the received measIdleDuration in VarMeasIdleConfig. In addition, the UE may drive a T331 timer based on the measIdleDuration value.
In case that measIdleConfig contains measIdleCarrierListNR, the UE may store the received measIdleCarrierListNR in VarMeasIdleConfig.
In case that measIdleConfig contains measIdleCarrierListEUTRA, the UE may store the received measIdleCarrierListEUTRA in VarMeasIdleConfig.
In case that measIdleConfig contains a validityAreaList, the UE may store the received validityAreaList in VarMeasIdleConfig.

In operation 1e-15, the UE in the RRC connected mode may transition to an RRC idle mode (RRC_IDLE).

In operation 1e-20, the UE in an RRC idle mode may obtain system information to camp-on to a suitable NR cell 1e-02. In addition, the UE may obtain or update an idle/inactive measurement configuration (measIdleConfigSIB) through system information broadcast by the cell. Further, the system information may include an indicator indicating whether the UE is required to perform idle/inactive measurements and indicating the UE to report measurements, if any, performed when establishing or resuming a connection to the corresponding cell (idleModeMeasurementNR which indicates that a UE that is configured for NR idle/inactive measurements shall perform the measurements while camping in this cell and report availability of these measurements when establishing or resuming a connection in this cell).

In operation 1e-25, the UE in the RRC idle mode may perform an idle/inactive measurement. Specifically, the UE in the RRC idle mode may perform the idle/inactive measurement while the T331 timer is running, and the specific UE operation is as follows.

| 1> | perform the measurements in accordance with the following: | |
|---|---|---|
| | 2> | if the VarMeasIdleConfig includes the measIdleCarrierListEUTRA and the SIB1 c |
| | | ontains idleModeMeasurementsEUTRA: |

| | |
|---|---|
| 3> | for each entry in measIdleCarrierListEUTRA within VarMeasIdleConfig: |

| | |
|---|---|
| 4> | if UE supports NE-DC between the serving carrier and the carrier frequency |
| | indicated by carrierFreqEUTRA within the corresponding entry: |

| | |
|---|---|
| 5> | perform measurements in the carrier frequency and bandwidth indicated |
| | by carrierFreq and allowedMeasBandwidth within the corresponding ent |
| | ry; |
| 5> | if the reportQuantitiesEUTRA is set to rsrq: |

| | |
|---|---|
| 6> | consider RSRQ as the sorting quantity; |

| | |
|---|---|
| 5> | else: |

| | |
|---|---|
| 6> | consider RSRP as the sorting quantity; |

| | |
|---|---|
| 5> | if the measCellListEUTRA is included: |

| | |
|---|---|
| 6> | consider cells identified by each entry within the measCellListEUTRA |
| | to be applicable for idle/inactive mode measurement reporting; |

| | |
|---|---|
| 5> | else: |

| | |
|---|---|
| 6> | consider up to maxCellMeasIdle strongest identified cells, according t |
| | o the sorting quantity, to be applicable for idle/inactive measurement r |
| | eporting; |

| | |
|---|---|
| 5> | for all cells applicable for idle/inactive measurement reporting, derive me |
| | asurement results for the measurement quantities indicated by reportQua |
| | ntitiesEUTRA; |
| 5> | store the derived measurement results as indicated by reportQuantitiesEU |
| | TRA within the measReportIdleEUTRA in VarMeasIdle Report in decreasi |
| | ng order of the sorting quantity, i.e. the best cell is included first, as follo |
| | ws: |

| | |
|---|---|
| 6> | if qualityThresholdEUTRA is configured: |

| | |
|---|---|
| 7> | include the measurement results from the cells applicable for idle/in |
| | active measurement reporting whose RSRP/RSRQ measurement re |
| | sults are above the value(s) provided in qualityThresholdEUTRA; |

| | |
|---|---|
| 6> | else: |

| | |
|---|---|
| 7> | include the measurement results from all cells applicable for idle/in |
| | active measurement reporting; |

| | |
|---|---|
| 2> | if the VarMeasIdleConfig includes the measIdleCarrierListNR and the SIB1 contai |
| | ns idleModeMeasurementsNR: |

| | |
|---|---|
| 3> | for each entry in measIdleCarrierListNR within VarMeasIdleConfig that contai |
| | ns ssb-MeasConfig: |

| | |
|---|---|
| 4> | if UE supports carrier aggregation or NR-DC between serving carrier and th |
| | e carrier frequency and subcarrier spacing indicated by carrierFreq and ssbS |
| | ubCarrierSpacing within the corresponding entry: |

| | |
|---|---|
| 5> | perform measurements in the carrier frequency and subcarrier spacing ind |
| | icated by carrierFreq and ssbSubCarrierSpacing within the correspondin |
| | g entry; |
| 5> | if the reportQuantities is set to rsrq: |

| | |
|---|---|
| 6> | consider RSRQ as the cell sorting quantity; |

| | |
|---|---|
| 5> | else: |

| | |
|---|---|
| 6> | consider RSRP as the cell sorting quantity; |

| | |
|---|---|
| 5> | if the measCellListNR is included: |

| | |
|---|---|
| 6> | consider cells identified by each entry within the measCellListNR to b |
| | e applicable for idle/inactive measurement reporting; |

| | |
|---|---|
| 5> | else: |

| | |
|---|---|
| 6> | consider up to maxCellMeasIdle strongest identified cells, according t |
| | o the sorting quantity, to be applicable for idle/inactive measurement r |
| | eporting; |

| | |
|---|---|
| 5> | for all cells applicable for idle/inactive measurement reporting and for the |
| | serving cell, derive cell measurement results for the measurement quantit |
| | ies indicated by reportQuantities; |
| 5> | store the derived cell measurement results as indicated by reportQuantitie |
| | s for the serving cell within measResultServingCell in the measReportIdle |
| | NR in VarMeasIdleReport; |
| 5> | store the derived cell measurement results as indicated by reportQuantitie |
| | s for cells applicable for idle/inactive measurement reporting within the |
| | measReportIdleNR in VarMeasIdle Report in decreasing order of the cell s |
| | orting quantity, i.e. the best cell is included first, as follows: |

| | |
|---|---|
| 6> | if qualityThreshold is configured: |

| | |
|---|---|
| 7> | include the measurement results from the cells applicable for idle/in |
| | active measurement reporting whose RSRP/RSRQ measurement re |
| | sults are above the value(s) provided in qualityThreshold; |

| | |
|---|---|
| 6> | else: |

| | |
|---|---|
| 7> | include the measurement results from all cells applicable for idle/in |
| | active measurement reporting; |

| | |
|---|---|
| 5> | if beamMeasConfigIdle is included in the associated entry in measIdleCa |
| | rrierListNR, for each cell in the measurement results: |

| | |
|---|---|
| 6> | derive beam measurements based on SS/PBCH block for each measur |
| | ement quantity indicated in reportQuantityRS-IndexesNR, as described |
| | in TS 38.215 [9]; |
| 6> | if the reportQuantityRS-Indexes is set to rsrq: |

| | |
|---|---|
| 7> | consider RSRQ as the beam sorting quantity; |

| | |
|---|---|
| 6> | else: |

| | |
|---|---|
| 7> | consider RSRP as the beam sorting quantity; |

| | |
|---|---|
| 6> | set resultsSSB-Indexes to include up to maxNrofRS-Indexes ToReport S |
| | S/PBCH block indexes in order of decreasing beam sorting quantity as |
| | follows: |

| | |
|---|---|
| 7> | include the index associated to the best beam for the sorting quantit |
| | y and if absThreshSS-BlocksConsolidation is included, the remaini |
| | ng beams whose sorting quantity is above absThreshSS-BlocksCons |
| | olidation; |

| | |
|---|---|
| 6> | if the includeBeamMeasurements is set to true: |

| | |
|---|---|
| 7> | include the beam measurement results as indicated by reportQuanti |
| | tyRS-Indexes; |

In other words, the above operations allow the UE in the RRC idle mode to store early measurement results (idle/inactive measurement results) in a VarMeasIdleReport, and measurement results for NR (measReportIdleNR) and/or measurement results for EUTRA (measReportIdleEUTRA) may be stored in the VarMeasIdleReport.

In operation 1e-30, the UE in the RRC idle mode may initiate a procedure for establishing an RRC connection with the NR base station 1e-02 (RRC connection establishment procedure). Specifically, in operation 1e-35, the UE may transmit an RRC connection setup request message (RRCSetupRequest) to the base station.

In operation 1e-40, the base station may transmit an RRC connection setup message (RRCSetup) to the UE. Upon receiving the RRC connection setup message, the UE may apply the RRC connection setup message and transition to the RRC connected mode (operation 1e-41).

In operation 1e-45, the UE in the RRC connected mode may transmit an RRC connection setup complete message (RRCSetupComplete) to the NR base station. The RRC connection setup complete message may contain the following pieces of information.
idleMeasAvailable: an indicator indicating that there are early measurement results measured in an RRC idle mode or RRC inactive mode.

In operation 1e-50, the base station may transmit a UEInformationRequest message to the UE in the RRC connected mode. The UEInformationRequest message may include an indicator (idleModeMeasurementReq) indicating to report early measurement results measured in the RRC idle mode or RRC inactive mode.

In operation 1e-55, the UE in the RRC connected mode, having received the UEInformationRequest message, may transmit a UEInformationResponse message to the NR base station in response thereto. The early measurement results measured in the RRC idle mode or RRC inactive mode may be received in the UEInformationResponse message. The early measurement results may refer to measResultIdleEUTRA and/or measResultIdleNR.

In operation 1e-60, the base station may transmit an RRC connection reconfiguration message (RRCReconfiguration) to the UE in the RRC connected mode. In other words, based on the information received in operation 1e-55, the base station may add an SCell or an SCG to the UE.

In operation 1e-65, the UE in the RRC connected mode may apply the received RRC connection reconfiguration message and transmit an RRC connection reconfiguration complete message (RRCReconfigurationComplete) to the base station.

A UE according to the disclosure performs early measurement when the UE is in an RRC idle mode and stores a measurement value associated therewith in a UE variable. In other words, the UE is characterized in that once the procedure for initiating the RRC connection establishment is performed, the early measurement is not performed thereafter.

FIG. 1F is a flow diagram illustrating an operation in which a UE in an RRC inactive mode (RRC_INACTIVE) stores and reports early measurement results according to the related art.

Referring to FIG. 1F, a UE 1f-01 may be in an RRC connected mode (RRC_CONNECTED) by establishing an RRC connection with an NR base station 1f-02 (operation 1f-05).

In operation 1f-10, the UE 1f-01 in the RRC connected mode may receive an RRCRelease message from the NR base station 1f-02. The message may contain suspend configuration information (suspendConfig) and a measIdleConfig containing an early measurement configuration (idle/inactive measurement configuration). The measConfig may contain at least one of the following pieces of information.
measIdleCarrierListNR: list of NR carriers to perform early measurement (idle/inactive measurement) in an RRC idle mode or RRC inactive mode (RRC_INACTIVE). Each NR carrier may contain at least one of the following pieces of information.

| | |
|---|---|
| MeasIdleCarrierNR-r16 ::= | SEQUENCE { |
| carrierFreq-r16 | ARFCN-ValueNR, |
| ssbSubcarrierSpacing-r16 | SubcarrierSpacing, |
| frequencyBandList | MultiFrequencyBandListNR |

OPTIONAL, -- Need R

| | |
|---|---|
| measCellListNR-r16 | CellListNR-r16 |

OPTIONAL, -- Need R

| | |
|---|---|
| reportQuantities-r16 | ENUMERATED {rsrp, rsrq, both}, |
| qualityThreshold-r16 | SEQUENCE { |
| idleRSRP-Threshold-NR-r16 | RSRP-Range |

OPTIONAL, -- Need R

| | |
|---|---|
| idleRSRQ-Threshold-NR-r16 | RSRQ-Range |

```
        OPTIONAL -- Need R
    }
OPTIONAL, -- Need R
```

| | |
|---|---|
| ssb-MeasConfig-r16 | SEQUENCE { |
| nrofSS-BlocksToAverage-r16 | INTEGER (2..maxNrofSS-BlocksToAverage |
| ) | OPTIONAL, -- Need S |

```
      absThreshSS-BlocksConsolidation-r16 ThresholdNR
        OPTIONAL, -- Need S
```

| | | |
|---|---|---|
| smtc-r16 | SSB-MTC | OPTI |

ONAL, -- Need S

| | |
|---|---|
| ssb-ToMeasure-r16 | SSB-ToMeasure |

OPTIONAL, -- Need S

| | |
|---|---|
| deriveSSB-IndexFromCell-r16 | BOOLEAN, |
| ss-RSSI-Measurement-r16 | SS-RSSI-Measurement |

OPTIONAL -- Need S

| | |
|---|---|
| } | OPTIONAL, -- N |

eed S

| | |
|---|---|
| beamMeasConfigIdle-r16 | BeamMeasConfigIdle-NR-r16 |

```
          OPTIONAL, -- Need R
    ...
}
```

measIdleCarrierListEUTRA: list of E-UTRA carriers to perform measurement in an RRC idle mode. Each E-UTRA carrier may contain at least one of the following pieces of information.

| | |
|---|---|
| MeasIdleCarrierEUTRA-r16 ::= | SEQUENCE { |
| carrierFreqEUTRA-r16 | ARFCN-ValueEUTRA, |
| allowedMeasBandwidth-r16 | EUTRA-AllowedMeasBandwidth, |
| measCellListEUTRA-r16 | CellListEUTRA-r16 |

OPTIONAL, -- Need R

| | |
|---|---|
| reportQuantitiesEUTRA-r16 | ENUMERATED {rsrp, rsrq, both}, |
| qualityThresholdEUTRA-r16 | SEQUENCE { |
| idleRSRP-Threshold-EUTRA-r16 | RSRP-RangeEUTRA |

OPTIONAL, -- Need R

| | |
|---|---|
| idleRSRQ-Threshold-EUTRA-r16 | RSRQ-RangeEUTRA-r16 |

```
            OPTIONAL -- Need R
    }
OPTIONAL, -- Need S
    ...
}
```

measIdleDuration: a duration value (T331 timer value) with regard to performing early measurement in an RRC idle mode or RRC inactive mode
validityAreaList: list of frequencies for which the UE is requested to perform early measurement in an RRC idle mode or RRC inactive mode and/or list of cells according to each frequency

The UE in the RRC connected mode may apply the measIdleConfig contained in the RRCRelease message. For example, in case that the measIdleConfig is set to setup,
The UE may store the received measIdleDuration in VarMeasIdleConfig. 1n addition, the UE may drive a T331 timer based on a measIdleDuration value.
In case that measIdleConfig contains measIdleCarrierListNR, the UE may store the received measIdleCarrierListNR in VarMeasIdleConfig.
In case that measIdleConfig contains measIdleCarrierListEUTRA, the UE may store the received measIdleCarrierListEUTRA in VarMeasIdleConfig.
In case that measIdleConfig contains a validityAreaList, the UE may store the received validityAreaList in VarMeasIdleConfig.

In operation 1f-15, the UE in the RRC connected mode may transition to the RRC inactive mode (RRC_INACTIVE).

In operation 1f-20, the UE in an RRC inactive mode may obtain system information to camp-on to a suitable NR cell 1f-02. In addition, the UE may obtain or update idle/inactive measurement configuration (measIdleConfigSIB) through system information broadcast by the cell. Further, the system information may include an indicator indicating whether the UE is required to perform idle/inactive measurements and indicating the UE to report measurements, if any, performed when establishing or resuming a connection to the corresponding cell (idleModeMeasurementNR which indicates that a UE that is configured for NR idle/inactive measurements shall perform the measurements while camping in this cell and report availability of these measurements when establishing or resuming a connection in this cell).

In operation 1f-25, the UE in the RRC inactive mode may perform idle/inactive measurement. Specifically, the UE in the RRC inactive mode may perform idle/inactive measurement while the T331 timer is running, and the specific UE operation is as follows.

| 1> | perform the measurements in accordance with the following: | |
|---|---|---|
| | 2> | if the VarMeasIdleConfig includes the measIdleCarrierListEUTRA and the SIB1 c |
| | | ontains idleModeMeasurementsEUTRA: |

| | |
|---|---|
| 3> | for each entry in measIdleCarrierListEUTRA within VarMeasIdleConfig: |

| | |
|---|---|
| 4> | if UE supports NE-DC between the serving carrier and the carrier frequency |
| | indicated by carrierFreqEUTRA within the corresponding entry: |

| | |
|---|---|
| 5> | perform measurements in the carrier frequency and bandwidth indicated |
| | by carrierFreq and allowedMeasBandwidth within the corresponding ent |
| | ry; |
| 5> | if the reportQuantitiesEUTRA is set to rsrq: |

| | |
|---|---|
| 6> | consider RSRQ as the sorting quantity; |

| | |
|---|---|
| 5> | else: |

| | |
|---|---|
| 6> | consider RSRP as the sorting quantity; |

| | |
|---|---|
| 5> | if the measCellListEUTRA is included: |

| | |
|---|---|
| 6> | consider cells identified by each entry within the measCellListEUTRA |
| | to be applicable for idle/inactive mode measurement reporting; |

| | |
|---|---|
| 5> | else: |

| | |
|---|---|
| 6> | consider up to maxCellMeasIdle strongest identified cells, according t |
| | o the sorting quantity, to be applicable for idle/inactive measurement r |
| | eporting; |

| | |
|---|---|
| 5> | for all cells applicable for idle/inactive measurement reporting, derive me |
| | asurement results for the measurement quantities indicated by reportQua |
| | ntitiesEUTRA; |
| 5> | store the derived measurement results as indicated by reportQuantitiesEU |
| | TRA within the measReportIdleEUTRA in VarMeasIdleReport in decreasi |
| | ng order of the sorting quantity, i.e. the best cell is included first, as follo |
| | WS: |

| | |
|---|---|
| 6> | if qualityThresholdEUTRA is configured: |

| | |
|---|---|
| 7> | include the measurement results from the cells applicable for idle/in |
| | active measurement reporting whose RSRP/RSRQ measurement re |
| | sults are above the value(s) provided in qualityThresholdEUTRA; |

| | |
|---|---|
| 6> | else: |

| | |
|---|---|
| 7> | include the measurement results from all cells applicable for idle/in |
| | active measurement reporting; |

| | |
|---|---|
| 2> | if the VarMeasIdleConfig includes the measIdleCarrierListNR and the SIB1 contai |
| | ns idleModeMeasurementsNR: |

| | |
|---|---|
| 3> | for each entry in measIdleCarrierListNR within VarMeasIdleConfig that contai |
| | ns ssb-MeasConfig: |

| | |
|---|---|
| 4> | if UE supports carrier aggregation or NR-DC between serving carrier and th |
| | e carrier frequency and subcarrier spacing indicated by carrierFreq and ssbS |
| | ubCarrierSpacing within the corresponding entry: |

| | |
|---|---|
| 5> | perform measurements in the carrier frequency and subcarrier spacing ind |
| | icated by carrierFreq and ssbSubCarrierSpacing within the correspondin |
| | g entry; |
| 5> | if the reportQuantities is set to rsrq: |

| | |
|---|---|
| 6> | consider RSRQ as the cell sorting quantity; |

| | |
|---|---|
| 5> | else: |

| | |
|---|---|
| 6> | consider RSRP as the cell sorting quantity; |

| | |
|---|---|
| 5> | if the measCellListNR is included: |

| | |
|---|---|
| 6> | consider cells identified by each entry within the measCellListNR to b |
| | e applicable for idle/inactive measurement reporting; |

| | |
|---|---|
| 5> | else: |

| | |
|---|---|
| 6> | consider up to maxCellMeasIdle strongest identified cells, according t |
| | o the sorting quantity, to be applicable for idle/inactive measurement r |
| | eporting; |

| | |
|---|---|
| 5> | for all cells applicable for idle/inactive measurement reporting and for the |
| | serving cell, derive cell measurement results for the measurement quantit |
| | ies indicated by reportQuantities; |
| 5> | store the derived cell measurement results as indicated by reportQuantitie |
| | s for the serving cell within measResultServingCell in the measReportIdle |
| | NR in VarMeasIdleReport; |
| 5> | store the derived cell measurement results as indicated by reportQuantitie |
| | s for cells applicable for idle/inactive measurement reporting within the |
| | measReportIdleNR in VarMeasIdle Report in decreasing order of the cell s |
| | orting quantity, i.e. the best cell is included first, as follows: |

| | |
|---|---|
| 6> | if qualityThreshold is configured: |

| | |
|---|---|
| 7> | include the measurement results from the cells applicable for idle/in |
| | active measurement reporting whose RSRP/RSRQ measurement re |
| | sults are above the value(s) provided in qualityThreshold; |

| | |
|---|---|
| 6> | else: |

| | |
|---|---|
| 7> | include the measurement results from all cells applicable for idle/in |
| | active measurement reporting; |

| | |
|---|---|
| 5> | if beamMeasConfigIdle is included in the associated entry in measIdleCa |
| | rrierListNR, for each cell in the measurement results: |

| | |
|---|---|
| 6> | derive beam measurements based on SS/PBCH block for each measur |
| | ement quantity indicated in reportQuantityRS-IndexesNR, as described |
| | in TS 38.215 [9]; |
| 6> | if the reportQuantityRS-Indexes is set to rsrq: |

| | |
|---|---|
| 7> | consider RSRQ as the beam sorting quantity; |

| | |
|---|---|
| 6> | else: |

| | |
|---|---|
| 7> | consider RSRP as the beam sorting quantity; |

| | |
|---|---|
| 6> | set resultsSSB-Indexes to include up to maxNrofRS-Indexes ToReport S |
| | S/PBCH block indexes in order of decreasing beam sorting quantity as |
| | follows: |

| | |
|---|---|
| 7> | include the index associated to the best beam for the sorting quantit |
| | y and if absThreshSS-BlocksConsolidation is included, the remaini |
| | ng beams whose sorting quantity is above absThreshSS-BlocksCons |
| | olidation; |

| | |
|---|---|
| 6> | if the includeBeamMeasurements is set to true: |

| | |
|---|---|
| 7> | include the beam measurement results as indicated by reportQuanti |
| | tyRS-Indexes; |

In other words, the above operations allow the UE in the RRC inactive mode to store early measurement results (idle/inactive measurement results) in VarMeasIdleReport, and measurement results for NR (measReportIdleNR) and/or measurement results for EUTRA (measReportIdleEUTRA) may be stored in the VarMeasIdleReport.

In operation 1f-30, the UE in RRC inactive mode may initiate a procedure for resuming an RRC connection with the NR base station 1f-02 (RRC connection resume procedure). Specifically, in operation 1f-35, the UE may transmit an RRC connection resume request message (RRCResumeRequest or RRCResumeRequest1) to the base station.

In operation 1f-40, the base station may transmit an RRC connection resume message (RRCResume) to the UE. The RRC connection resume message may include an indicator (idleModeMeasurementReq) indicating to report early measurement results measured in the RRC idle mode or RRC inactive mode. Upon receiving an RRC resume setup message, the UE may apply an RRC resume setup message and transition to the RRC connected mode (operation 1f-41).

In operation 1f-45, the UE in the RRC connected mode may transmit an RRC resume complete message (RRCResumeComplete) to the NR base station. The RRC connection resume complete message may include at least one of the following pieces of information.
The RRC connection resume complete message may contain early measurement results measured in the RRC idle mode or RRC inactive mode. Early measurement results may refer to measResultIdleEUTRA and/or measResultIdleNR.
In case that there is no an idleModeMeasurementReq indicator, when there are early measurement results measured in the RRC idle mode or RRC inactive mode, the RRC connection resume message may include an idleMeasAvailable indicator. In this case, the early measurement results may be retrieved by the base station from the UE according to the embodiment described above.

In operation 1f-50, the base station may transmit an RRC connection reconfiguration message (RRCReconfiguration) to the UE in the RRC connected mode. In other words, based on the information received in operation 1f-45, the base station may add an SCell or SCG to the UE.

In operation 1f-55, the UE in the RRC connected mode may apply the received RRC connection reconfiguration message and transmit an RRC connection reconfiguration complete message (RRCReconfigurationComplete) to the base station.

A UE according to the disclosure performs an early measurement when the UE is in an RRC inactive mode and stores a measurement value associated therewith in a UE variable. In other words, once the procedure of initiating the resumption of the RRC connection is performed, the early measurement is not performed thereafter.

FIG. 1G is a flow diagram illustrating an operation in which a base station enables a UE to perform enhanced early measurement results in a next-generation mobile communication system according to an embodiment of the disclosure.

Referring to FIG. 1G, a UE 1g-01 may be in an RRC connected mode (RRC_CONNECTED) by establishing an RRC connection with an NR base station 1g-02 (operation 1g-05).

In operation 1g-10, the UE may transmit a UE capability information message (UECapabilityInformation) to the base station. This operation may follow the embodiments described above. Further, the message may include at least one of the following pieces of information.
The UE capability information message may include capability information capable of performing early measurement when performing an RRC connection establishment procedure or an RRC resume procedure or even after completion of an RRC connection establishment procedure or an RRC resume procedure, storing the early measurement results associated therewith, and reporting them to the base station. In the disclosure, the performance of the early measurement when performing the RRC connection establishment procedure or RRC resume procedure, or even after completion of the RRC connection establishment procedure or RRC resume procedure, may be referred to as enhanced early measurement.
According to the disclosure, enhanced early measurement may only be performed in frequency range 2 (FR 2). Of course, the enhanced early measurement may be supported regardless of FR.
The message may include capability information about whether the enhanced early measurement capability supports a new validity area.
The new validity area may refer to information about an area in which enhanced early measurement should be performed. For example, the new validity area refers to the following pieces of information.
Frequency information indicating FR2 (e.g., absolute radio frequency channel number (ARFCN)).
Optional cell list for each of the above frequencies
In case that there is a cell list for the corresponding frequency, this may indicate that enhanced early measurement should be performed on all cells in the indicated frequency.
In case that there is a cell list for the corresponding frequency, this may indicate that enhanced early measurement should only be performed for a cell list configured in the indicated frequency.

In operation 1g-15, the UE 1g-01 in the RRC connected mode may receive an RRCRelease message from the NR base station 1g-02. This operation may follow the embodiments described above. Further, the message may include the enhanced early measurement configuration described above, which may refer to configuration information including at least one of the following.
Information about frequencies where enhanced early measurement should be performed
The frequency information may include only frequency information for FR2, or may include all frequency information regardless of FR. The information may be contained in an RRC disconnect message separate from the early measurement configuration (idle/inactive measurement configuration) described above.
Information on a new validation area in which enhanced early measurement should be performed
The frequency information may include information about an area in which the UE should perform enhanced early measurement, and may be configured specifically as follows.
Frequency information indicating FR2 (e.g., absolute radio frequency channel number (ARFCN)).
Of course, any frequency information may be included, regardless of FR.
Optional cell list for each of the above frequencies
In case that there is no list of cells in the corresponding frequency, this may indicate that enhanced early measurement should be performed on all cells in the indicated frequency.
In case that there is a cell list in the corresponding frequency, this may indicate that enhanced early measurement should only be performed for a cell list configured in the indicated frequency.

The base station according to the disclosure may configure, for the UE, the new validity area information together when configuring the enhanced early measurement configuration through the RRC disconnect message. Since not all cells in a specific frequency may support enhanced early measurement and there may be cells for which the base station does not quickly establish, in the UE, an SCell or SCG operating in a specific frequency, there is an advantage in that by configuring new validity area information, the UE may not perform enhanced early measurement unnecessarily and the base station may not receive enhanced early measurement results from the UE unnecessarily.

FIG. 1H is a flow diagram illustrating an operation in which a UE that is configured to perform enhanced early measurement in a next-generation mobile communication system transmits, to a base station, an indicator indicating information about the presence or absence of a resultant value for the measurement, or an indicator or information indicating that the measurement should continue to be performed according to an embodiment of the disclosure.

Referring to FIG. 1H, a UE 1h-01 may be in an RRC connected mode (RRC_CONNECTED) by establishing an RRC connection with an NR base station 1h-02.

In operation 1h-10, the UE may transmit a UE capability information message (UECapabilityInformation) to the base station. This operation may follow the embodiments described above.

In operation 1h-15, the UE 1h-01 in the RRC connected mode may receive an RRCRelease message from the NR base station 1h-02. This operation may follow the embodiments described above.

In operation 1h-20, the UE may apply the received RRCRelease message and transition to an RRC idle mode (RRC_IDLE) or RRC inactive mode (RRC_INACTIVE).

In operation 1h-25, the UE may obtain system information currently broadcast by the serving cell. The system information may include at least one of the following.
An indicator (enhancedidleModeMeasurementsNR) indicating whether the UE is required to perform enhanced early measurements and indicating the UE to report the enhanced early measurements performed when establishing or resuming an RRC connection to the corresponding cell
Pieces of Frequency information (enhancedmeasIdleConfigSIB) by which the UE is able to perform enhanced early measurement

In operation 1h-30, the UE may perform enhanced early measurement. For reference, this operation may be performed independently of the T331 timer being driven, and the specific operation may follow the above embodiments. Furthermore, in case that the UE fails to derive a valid result value, the performing of the measurement may continue during the RRC connection establishment procedure or the RRC resume procedure, and after completion of the RRC connection establishment procedure or the RRC resume procedure.

In operation 1h-35, the UE may initiate an RRC connection establishment or RRC connection resume procedure to establish an RRC connection with the base station 1h-02 or to resume an RRC connection. In contrast to the embodiments described above, in case that the UE fails to derive a valid result value for the frequencies/cells for which the UE is instructed to perform the enhanced early measurement, the UE may continue to perform the enhanced early measurement. The RRC connection establishment procedure or the RRC connection resume procedure may follow the embodiments described above, and only the differences from the embodiments described above are described herein.

In operation 1h-40, the UE 1h-01 having transitioned to the RRC connected mode may transmit, to the base station 1h-02, an RRC connection setup complete message (RRCSetupComplete) or an RRC connection resume complete message (RRCResumeComplete). In the disclosure, the message includes at least one of the following.
In case that the UE has a valid result value obtained by performing an enhanced early measurement on one or multiple frequencies/cells, an indicator (enhancedidleMeasAvailable) indicating that the UE has the valid result value may be included in the message.
In case that the UE continues to perform enhanced early measurements on one or multiple frequencies/cells (i.e., further measurements are performed because no valid result values are derived), an indicator (enhancedidleMeasOngoing) indicating that enhanced early measurements are being performed continuously may be included in the message.
The UE may transmit, together with the indicators, cell information or intra-frequency cell information related to cells on which enhanced early measurement is desired to be continuously performed. For reference, this information may be limited to the RRC connection resume complete message where there are no safety concerns.

In operation 1h-45, the base station 1h-02 may transmit a UEInformationRequest message to the UE 1h-01 in the RRC connected mode. The UEInformationRequest message may include an indicator (enhancedidleModeMeasurementReq) indicating to report enhanced early measurement results.

In operation 1h-50, the UE that has received the UEInformationRequest message may transmit a UEInformationResponse message to the base station in response thereto. The message may include information about the enhanced measurement results via at least one of the following methods (i.e., any combination of the following methods may be performed, or only one of the following methods may be performed).
Method 1: In case that there are valid enhanced early measurement results (enhancedmeasResultIdleNR), the enhanced early measurement results may be included in the message. In this case, if there is even one valid result value, the valid result value may be included in the message. Alternatively, the message may include all valid result values after waiting for all to be derived.
Method 2: In case that the UE continues to perform enhanced early measurements n one or multiple frequencies or cells, an indicator (enhancedidleMeasOngoing) indicating that enhanced early measurements are being performed continuously may be included in the message. The absence of the indicator may mean that the UE is no longer performing enhanced early measurements, or it may mean that all valid enhanced early measurement results are included in the message.
Method 3: In case that the UE continues to perform enhanced early measurements on one or more frequencies or cells, time information for performing the measurements may be included in the message.
Method 4: In case that the UE continues to perform enhanced early measurements on one or more frequencies or cells, frequency or cell information regarding thereto is included in the message.

The UE may release the information about the enhanced early measurement results when the UE has successfully transmitted the enhanced early measurement results by including them in the message. The UE may release only the enhanced early measurement results transmitted to the base station, or may release all stored enhanced early measurement results after operation 1h-50 and stop performing enhanced early measurements.

In operation 1h-55, the base station may transmit an RRC message (e.g., an RRC connection reconfiguration message (RRCReconfiguration)) to the UE in the RRC connected mode. Operation 1h-55 may be performed before operation 1h-45. In the disclosure, the enhanced early measurement may be stopped and information about the enhanced early measurement may be released upon receipt of the first RRC connection reestablishment message, or upon receipt of the RRC connection reestablishment message after receipt of the UEInformationRequest message containing the enhancedidleModeMeasurementReq, or when a predetermined RRC message explicitly includes an indicator to stop performing the enhanced early measurement.

FIG. 1I illustrates an internal structure of a UE according to an embodiment of the disclosure.

Referring to FIG. 1I, the UE includes a radio frequency (RF) processor 1i-10, a baseband processor 1i-20, a storage 1i-30, and a controller 1i-40.

The RF processor 1i-10 performs functions for transmitting and receiving signals via a wireless channel, such as band conversion and amplification of signals. In other words, the RF processor 1i-10 up-converts a baseband signal provided from the baseband processor 1i-20 into an RF band signal and transmits the same via an antenna, and down-converts the RF band signal received via the antenna into a baseband signal. For example, the RF processors 1i-10 includes a transmit filter, a receive filter, an amplifier, a mixer, an oscillator, a digital-to-analog converter (DAC), an analog-to-digital converter (ADC), and the like. In FIG. 1I, only one antenna is shown, but the UE may include a plurality of antennas. Further, the RF processors 1i-10 may include a plurality of RF chains. Further, the RF processors 1i-10 may perform beamforming. For the beamforming, the RF processor 1i-10 may adjust the phase and magnitude of each of the signals transmitted and received through the plurality of antennas or antenna elements. Further, the RF processor may perform MIMO, and may receive multiple layers when performing MIMO operation.

The baseband processor 1i-20 performs conversion functions between baseband signals and bit strings according to the physical layer specifications of the system. For example, when transmitting data, the baseband processor 1i-20 encodes and modulates a transmitted bit stream to generate complex symbols. In addition, when receiving data, the baseband processor 1i-20 demodulates and decodes the baseband signal provided from the RF processor 1i-10 to restore a received bit stream. For example, in the case of orthogonal frequency division multiplexing (OFDM) scheme, when transmitting data, the baseband processor 1i-20 generates complex symbols by encoding and modulating the transmitted bit stream, maps the complex symbols to subcarriers, and then configures OFDM symbols by performing an inverse fast Fourier transform (IFFT) operation and inserting a cyclic prefix (CP). In addition, when receiving data, the baseband processor 1i-20 may split the baseband signal provided from the RF processor 1i-10 into OFDM symbol units and restore the signals mapped to the subcarriers by performing a fast Fourier transform (FFT) operation and then reconstruct the received bit streams by performing demodulation and decoding.

The baseband processor 1i-20 and the RF processor 1i-10 may transmit and receive signals as described above. Accordingly, the baseband processor 1i-20 and the RF processor 1i-10 may be referred to as a transmitter, a receiver, a transceiver, or a communicator. At least one of the baseband processor 1i-20 and the RF processor 1i-10 may include a plurality of communication modules to support different wireless access technologies. In addition, at least one of the baseband processor 1i-20 and the RF processor 1i-10 may include different communication modules configured to process signals of different frequency bands. For example, the different wireless access technologies includes a wireless LAN (e.g., IEEE 802.11), a cellular network (e.g., LTE), and the like. In addition, the different frequence bands may include a super high frequency (SHF) band (e.g., 2.NRHz or NRHz), and a millimeter wave (e.g., 60 GHz) band.

The storage 1i-30 may store data such as a basic program, an application program, and configuration information for the operations of the UE. In particular, the storage 1i-30 may store information related to a second access node performing wireless communication using a second wireless access technology. The storage 1i-30 may provide the stored data according to a request from the controller 1i-40.

The controller 1i-40 may control overall operations of the UE. For example, the controller 1i-40 transmits and receive signals through the baseband processor 1i-20 and the RF processor 1i-10. In addition, the controller 1i-40 may record and read the data on the storage 1i-30. To this end, the controller 1i-40 may include at least one processor. For example, the controller 1i-40 includes a communication processor (CP) 1i-42 that performs control for communication and an application processor (AP) that controls higher layers such as applications.

FIG. 1J is a block diagram illustrating a configuration of an NR base station according to an embodiment of the disclosure.

Referring to FIG. 1J, the base station includes an RF processor 1j-10, a baseband processor 1j-20, a backhaul communicator 1j-30, a storage 1j-40, and a controller 1j-50.

The RF processor 1j-10 performs functions for transmitting and receiving signals via a wireless channel, such as band conversion and amplification of signals. In other words, the RF processor 1j-10 upconverts a baseband signal provided from the baseband processor 1j-20 into an RF band signal and transmits the same via an antenna, and down-converts an RF band signal received via the antenna into a baseband signal. For example, the RF processors 1j-10 includes a transmission filter, a reception filter, an amplifier, a mixer, an oscillator, a DAC, an ADC, and the like. In FIG. 1J, only one antenna is shown, but the first access node may include a plurality of antennas. Further, the RF processors 1j-10 may include a plurality of RF chains. Further, the RF processors 1j-10 may perform beamforming. For the beamforming, the RF processor 1j-10 may adjust the phase and magnitude of each of the signals transmitted and received through the plurality of antennas or antenna elements. The RF processor may perform downward MIMO operation by transmitting one or more layers.

The baseband processor 1j-20 performs conversion functions between baseband signals and bit strings according to the physical layer specifications of the first wireless access technology. For example, when transmitting data, the baseband processor 1j-20 encodes and modulates a transmitted bit stream to generate complex symbols. In addition, when receiving data, the baseband processor 1j-20 demodulates and decodes the baseband signal provided from the RF processor 1j-10 to restore a received bit stream. For example, in the case of OFDM scheme, when transmitting data, the baseband processor 1j-20 generates complex symbols by encoding and modulating the transmitted bit stream, maps the complex symbols to subcarriers, and then configures OFDM symbols by performing an IFFT operation and inserting a CP. In addition, when receiving data, the baseband processor 1j-20 may split the baseband signal provided from the RF processor 1j-10 into OFDM symbol units and restore the signals mapped to the subcarriers by performing an FFT operation, and then reconstruct the received bit streams by performing demodulation and decoding. The baseband processor 1j-20 and the RF processor 1j-10 may transmit and receive signals as described above. Accordingly, the baseband processor 1j-20 and the RF processor 1j-10 may be referred to as a transmitter, a receiver, a transceiver, a communicator, or wireless communicator.

The backhaul communicator 1j-30 provides an interface for performing communication with other nodes in the network. In other words, the backhaul communicator 1j-30 converts a bit stream transmitted from the main base station to another node, for example, a secondary base station, a core network, etc. into a physical signal, and converts a physical signal received from the other node into a bit stream.

The storage 1j-40 may store data such as a basic program, an application program, and configuration information for the operations of the main base station. In particular, the storage 1j-40 may store information about a bearer assigned to an accessed UE, measurement results reported by the accessed UE, and the like. In addition, the storage 1j-40 may store information that is the basis for determining whether to provide or terminate multiple connections to a UE. Furthermore, the storage 1j-40 provides the stored data according to a request from the controller 1j-50.

The controller 1j-50 may control overall operations of the main base station. For example, the controller 1j-50 transmits and receive signals through the baseband processor 1j-20 and the RF processor 1j-10 or through the backhaul communicator 1j-30. In addition, the controller 1j-50 may record and read the data on the storage 1j-40. To this end, the controller 1j-50 may include at least one processor 1j-52.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
receiving, from a base station, a radio resource control (RRC) release message including measurement configuration information;
entering an RRC idle state or an RRC inactive state, based on the RRC release message;
receiving, from the base station, system information including information indicating whether the terminal performs a measurement while camping on a cell and report an availability of the measurement in case of establishing or resuming a connection in the cell;
performing the measurement, based on the measurement configuration information in the RRC idle state or the RRC inactive state;
performing an RRC connection procedure with the base station;
receiving, from the base station, a user equipment (UE) information request message including a request for a validated measurement; and
transmitting, to the base station, a UE information response message including the validated measurement.

2. The method of claim 1, further comprising:
in case that the transmission of the UE information response message is successful, discarding a measurement result.

3. The method of claim 1,
wherein the performing of the RRC connection procedure further comprises transmitting an RRC setup complete message or an RRC resume complete message, and
wherein the RRC setup complete message or the RRC resume complete message includes information indicating that the terminal has an available measurement result.

4. The method of claim 1, wherein the measurement configuration information comprises at least one of a carrier list associated with new radio (NR), a carrier list associated with long-term evolution (LTE), duration information, and a frequency list.

5. A method performed by a base station in a wireless communication system, the method comprising:
transmitting a radio resource control (RRC) release message including measurement configuration information to a terminal;
transmitting, based on the RRC release message, to a terminal in an RRC idle state or an RRC inactive state, system information including information indicating whether a measurement is performed while the terminal camps on a cell and report an availability of the measurement in case of establishing or resuming a connection in the cell;
performing an RRC connection procedure with the terminal;
transmitting, to the terminal, a user equipment (UE) information request message including a request for a validated measurement; and
receiving, from the terminal, a UE information response message including the validated measurement.

6. The method of claim 5,
wherein performing the RRC connection procedure further comprises receiving an RRC setup complete message or an RRC resume complete message, and
wherein the RRC setup complete message or the RRC resume complete message includes information indicating that the terminal has an available measurement result.

7. The method of claim 5, wherein the measurement configuration information comprises at least one of a carrier list associated with new radio (NR), a carrier list associated with long-term evolution (LTE), duration information, and a frequency list.

8. A terminal in a wireless communication system, the terminal comprising:
a transceiver; and
a controller connected to the transceiver,
wherein the controller is configured to:
receive, from a base station, a radio resource control (RRC) release message including measurement configuration information,
enter an RRC idle state or an RRC inactive state, based on the RRC release message,
receive, from the base station, system information including information indicating whether the terminal performs a measurement while camping on a cell and report an availability of the measurement in case of establishing or resuming a connection in the cell,
perform the measurement, based on the measurement configuration information in the RRC idle state or the RRC inactive state,
perform an RRC connection procedure with the base station,
receive, from the base station, a user equipment (UE) information request message including a request for a validated measurement, and
transmit, to the base station, a UE information response message including the validated measurement.

9. The terminal of claim 8, wherein the controller is further configured to, in case that the transmission of the UE information response message is successful, discard a measurement result.

10. The terminal of claim 8,
wherein the controller is further configured to transmit an RRC setup complete message or an RRC resume complete message, and
wherein the RRC setup complete message or the RRC resume complete message includes information indicating that the terminal has an available measurement result.

11. The terminal of claim 8, wherein the measurement configuration information comprises at least one of a carrier list associated with new radio (NR), a carrier list associated with long-term evolution (LTE), duration information, and a frequency list.

12. A base station in a wireless communication system, the base station comprising:
a transceiver; and
a controller connected to the transceiver,
wherein the controller is configured to:
transmit a radio resource control (RRC) release message including measurement configuration information to a terminal,
transmit, based on the RRC release message, to a terminal in an RRC idle state or an RRC inactive state, system information including information indicating whether a measurement is performed while the terminal camps on a cell and report an availability of the measurement in case of establishing or resuming a connection in the cell,
perform an RRC connection procedure with the terminal,
transmit, to the terminal, a user equipment (UE) information request message including a request for a validated measurement, and
receive, from the terminal, a UE information response message including the validated measurement.

13. The base station of claim 12,
wherein the controller is configured to receive an RRC setup complete message or an RRC resume complete message, and
wherein the RRC setup complete message or the RRC resume complete message includes information indicating that the terminal has an available measurement result.

14. The base station of claim 12, wherein the measurement configuration information comprises at least one of a carrier list associated with new radio (NR), a carrier list associated with long-term evolution (LTE), duration information, and a frequency list.
